(19) United States
(12) Patent Application Publication
(10) Pub. No.: US 2022/0095715 A1
(43) Pub. Date: Mar. 31, 2022

(54) Facemask With Electronic Components

(71) Applicant: Barbara C Ferrer, Newnan, GA (US)

(72) Inventor: Barbara C Ferrer, Newnan, GA (US)

(21) Appl. No.: 17/487,811

(22) Filed: Sep. 28, 2021

Related U.S. Application Data
(60) Provisional application No. 63/084,349, filed on Sep. 28, 2020.

(51) Int. Cl. A41D 13/11; A62B 18/08; A62B 23/02; H05B 45/10; H05B 47/19; H04R 1/08; H04R 3/00

(52) U.S. Cl. CPC A41D 13/11; A62B 18/084; A62B 23/025; H04R 2420/07; H05B 47/19; H04R 1/08; H04R 3/00; H05B 45/10

(57) ABSTRACT

A facemask with electronic components includes a mask body with one or more straps configured to secure the mask body around to the head of a wearer, such that the mouth and nose of the wearer are covered. The electronic components include a power supply operably connected to a microphone, a speaker, a microprocessor, a plurality of LEDs connected to an LED controller, and a wireless transceiver. The wireless transceiver is configured to receive command instructions from a remote device's wireless transceiver. Upon receiving the corresponding command instructions, the microprocessor is configured to cause the plurality of LEDs to illuminate in a desired pattern. Further, the microprocessor is configured to transmit the audio recorded by the microphone either one of or both of the onboard speaker and a remote speaker via the wireless transceiver. The facemask provides protection from airborne contaminants as well as enhanced communication and entertainment features.

### CROSS REFERENCE TO RELATED APPLICATIONS

This application claims the benefit of U.S. Provisional Application No. 63/084,349, filed on Sep. 28, 2020. The above identified patent application is herein incorporated by reference in its entirety to provide continuity of disclosure.

### BACKGROUND OF THE INVENTION

The present invention relates to a protective facemask. More specifically, the present invention provides a facemask that includes multiple electronic components, such as programmable LEDs and speakers, which enhance the wearer's communication capabilities and provide enhanced entertainment value.

Many individuals wear facemasks to protect themselves from the unwanted inhalation of bacteria, viral particles, pollution particles, pollen, and other airborne contaminants. In public settings such as restaurants, clubs, venues, and the like, it may be more desirable to wear such a facemask due to the increased number of individuals in close proximity to one another. One drawback to facemasks is that they muffle the wearer's voice. It can be difficult to hear and understand an individual wearing a facemask. Sometimes, individuals remove their facemasks so that they can be heard more easily, but this can cause the unwanted particles to enter their system. As one example, DJ's, musicians, singers, and other entertainers must often remove their facemask in such settings in order to be heard for their performance. This can cause unsafe conditions for the entertainer and other individuals surrounding them. In order to address these concerns, the present invention provides a facemask with a microphone and onboard speakers for projecting their amplified voice as recorded by the microphone, as well as the ability to amplify and transmit their voice to a remote speaker.

Devices have been disclosed in the known art that relate to facemasks with microphones. These include devices that have been patented and disclosed in patent application publications. However, the devices in the known art have several drawbacks. For example, these devices typically do not have a mechanism for separating the microphone and other electronics from the facemask. This makes it difficult or impossible to sterilize and clean the facemask without damaging the microphone and other electronic components. Further, these devices typically lack the ability to transmit audio to either one of or both of an onboard speaker and a remote external speaker. Additionally, the facemasks in the known art lack a programmable LED display, which can be desirable for providing entertainment value for certain users of the facemask.

In light of the systems disclosed in the known art, it is submitted that the present invention substantially diverges in design elements from the known art and consequently it is clear that there is a need in the art for an improvement to existing facemasks and similar devices. In this regard the present invention substantially fulfills these needs.

### SUMMARY OF THE INVENTION

The present invention provides a facemask with electronic components wherein the same can be utilized for amplify the voice of the wearer via onboard and remote speakers, and providing additional entertainment value and aesthetic customization via programmable LEDs. The facemask with electronic components generally includes a mask body including one or more straps configured to secure the mask body around to the head of a wearer, such that the mouth and nose of the wearer are covered by the mask body. The electronic components include a power supply operably connected to a microphone, a speaker, a microprocessor, a plurality of LEDs operably connected to an LED controller, and a wireless transceiver.

The microprocessor is operably connected to the LED controller and a non-transitory computer readable medium. A logic is stored in the non-transitory computer readable and, when executed by the microprocessor, causes the facemask to perform a method. The method includes receiving, from a remote device and via the wireless transceiver, a command instruction comprising one or more LED patterns. The microprocessor then activates the LED controller to cause the plurality of LEDs to illuminate in the one or more LED patterns. Further, the method may include receiving, from the remote device and via the wireless transceiver, an instruction to transmit audio recorded by the microphone to either one of or both of a remote speaker and the facemask speaker.

One object of the present invention is to provide a facemask with electronic components that allows the electronics to be separated from the mask body to protect them from damage when sterilizing or cleaning the facemask.

Another object of the present invention is to provide a facemask with electronic components that includes adjustable and comfortable securement mechanisms so that the wearer can be comfortable when wearing the facemask for extended periods of time.

A further object of the present invention is to provide a facemask with electronic components that includes multi-colored programmable LED strands woven throughout its exterior layer, such that the wearer can customize the colors and patterns on their facemask.

Another object of the present invention is to provide a facemask with electronic components that includes enhancement features for the microphone, such as an internal pop filter, internal noise cancelling software, or programmable input sensitivity.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an exterior side of an embodiment of the facemask with electronic components.

FIG. 2 shows a perspective view of an interior side of an embodiment of the facemask with electronic components.

FIG. 3 shows a side elevation view of an exterior side of an embodiment of the facemask with electronic components.

FIG. 4 shows a block diagram of the electronic elements of an embodiment of the facemask with electronic components, as well as external devices that interact with the facemask.

### DETAILED DESCRIPTION OF THE INVENTION

According to some embodiments, the operations, techniques, and/or components described herein can be implemented as (i) a special-purpose computing device having specialized hardware and a logic hardwired into the computing device to persistently perform the disclosed operations and/or techniques or (ii) a logic that is implementable on an electronic device having a general purpose hardware processor to execute the logic and a computer-readable medium, e.g. a memory, wherein implementation of the logic by the processor on the electronic device provides the electronic device with the function of a special-purpose computing device.

In the interests of economy, the present disclosure refers to “a computer-readable medium,” “a microprocessor,” and so on. However, this should not be read as limiting in any way as the present disclosure contemplates embodiments of the present invention utilizing “one or more computer-readable media,” “one or more microprocessors,” and so on. Unless specifically limited to a single unit, “a” is intended to be equivalent to “one or more” throughout the present, disclosure.

According to some embodiments, the operations, techniques, and/or components described herein can be implemented by an electronic device, which can include one or more special-purpose computing devices. The special-purpose computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more general purpose hardware processors programmed to perform such features of the present disclosure pursuant to program instructions in firmware, memory, other storage, or a combination. Such special-purpose computing devices can also combine custom hard-wired logic, ASICs, or FPGAs with custom programming to accomplish the technique and other features of the present disclosure. The special-purpose computing devices can be desktop computer systems, portable computer systems, handheld devices, networking devices, or any other device that incorporates hard-wired and/or program logic to implement the techniques and other features of the present disclosure.

Reference is made herein to the attached drawings. Like reference numerals are used throughout the drawings to depict like or similar elements of the facemask with electronic components. For the purposes of presenting a brief and clear description of the present invention, a preferred embodiment will be discussed as used for providing a facemask that filters unwanted contaminants and also includes onboard or remote voice amplification and programmable LEDs. The figures are intended for representative purposes only and should not be considered to be limiting in any respect.

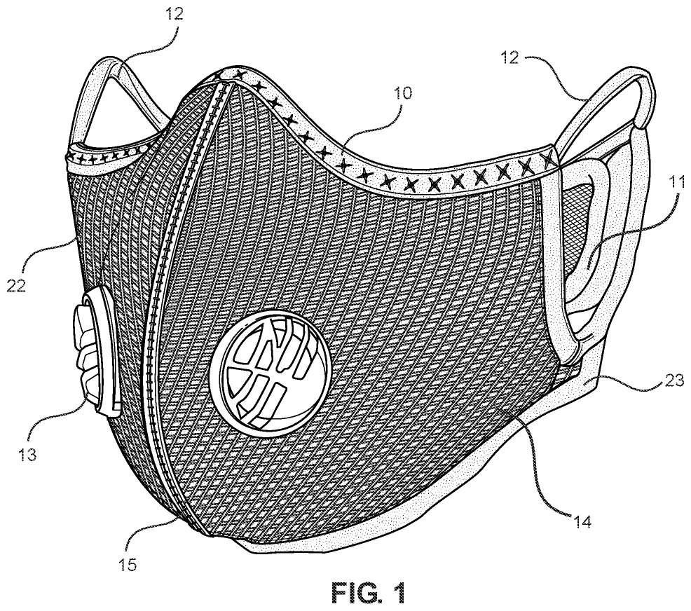

Referring now to FIG. 1, there is shown a perspective view of an exterior side of an embodiment of the facemask with electronic components. The present invention includes a mask body 10 including one or more straps configured to secure the mask body 10 around to the head of a wearer, such that the mouth and nose of the wearer are covered by the mask body 10. This causes the air inhaled through the nose or mouth to be filtered at least by the material of the mask body 10. The mask body 10 can be composed of any suitable material. In some embodiments, the material is one adapted to maintain an N95 filter rating. In some embodiments, the material includes an inner layer of material, an outer layer of material, and a filter layer between the inner layer of material and outer layer of material. This can provide enhanced filtration. Further, some embodiments may include a filter layer that is removably secured between the inner layer of material and outer layer of material via a pocket. This can allow the user to sterilize the filter or replace the filter with a new one if needed.

In the shown embodiment, the one or more straps include a pair of ear straps 12 and an adjustable head strap 11. This allows multiple adjustable options for securing the mask body 10 to the wearer. Other embodiments may include different types and combinations of adjustable straps. The exterior layer 15 of the mask body 10 further includes at least one speaker 13 attached thereto. In the shown embodiment, the mask body 10 includes a first speaker 13 disposed on a first side 22 of the mask body 10 and a second speaker 13 disposed on a second side 23 of the mask body 10. This allows for stereo audio configurations when transmitting audio through the pair of speakers 13. Further, this configuration can project the recorded audio in multiple directions, making it easier to hear in a crowded location.

The exterior layer 15 of the mask body 10 further includes a plurality of LED strands 14. The LED strands 14 include different color strands or strands that can emit different colors depending on programming instructions. In the shown embodiment, the LED strands 14 are woven in an interlocking pattern through the exterior layer 15 of the mask body. In other embodiment, the LED strands 14 can be attached directly on top of the exterior layer 15 of the mask body 10 via permanent attachment or removable fasteners, which would allow the strands 14 to be removed when cleaning the mask body 10. In all embodiments, the LED strands 14 can be programmed via an external remote device to flash in any desired color, pattern, or duration, which provides a customizable entertainment option.

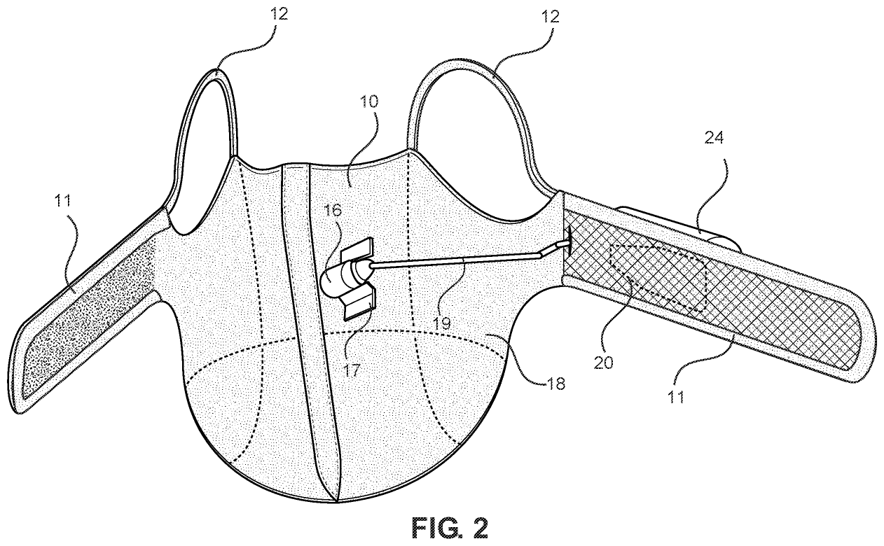

Referring now to FIG. 2, there is shown a perspective view of an interior side of an embodiment of the facemask with electronic components. In the shown embodiment, the interior side 18 of the mask body 10 is secured to the wearer via the pair of elastic ear loops 12 which allow for adjustment, and a head strap 11 which includes a hook and loop fastener strip for further adjustment. A microphone 16 is secured within the interior side 18 of the mask body. The microphone 16 is configured to pick up and amplify the voice of the wearer. In some embodiments, the microphone 16 is embedded within the mask body 10. In the shown embodiment, the microphone 16 is secured within the mask body 10 via a fastener, such as a clip 17. This allows the microphone to be removed when not needed, or when cleaning the mask body 10 to prevent damage to the microphone's 16 components. In other embodiments, the microphone 16 may be secured within an interior pocket within the mask body 10.

In the shown embodiment, the microphone 16 includes a wired connection 19 to an electronics housing 20. In some embodiments, the wired connection 19 comprises a flexible, adjustable cable that can be moved to position the microphone 16 in a comfortable location. In the shown embodiment, the electronics housing 20 is removably secured within a pocket 24, allowing it to be removed when cleaning the mask body 10. In some embodiments, the microphone 16 includes an internal pop filter that enhances the voice quality and prevents breathes or other unwanted sounds from being amplified. In other embodiments, the filter layer of the mask is adapted to act as a pop filter for the microphone 16. In other embodiments, the microphone 16 and wired connection 19 can be obscured or covered by a pocket that holds a removable pop filter. This arrangement also prevents the microphone 16 and wired connection 19 from contacting the face of the wearer, since the exterior of the pop filter pocket would contact the wearer.

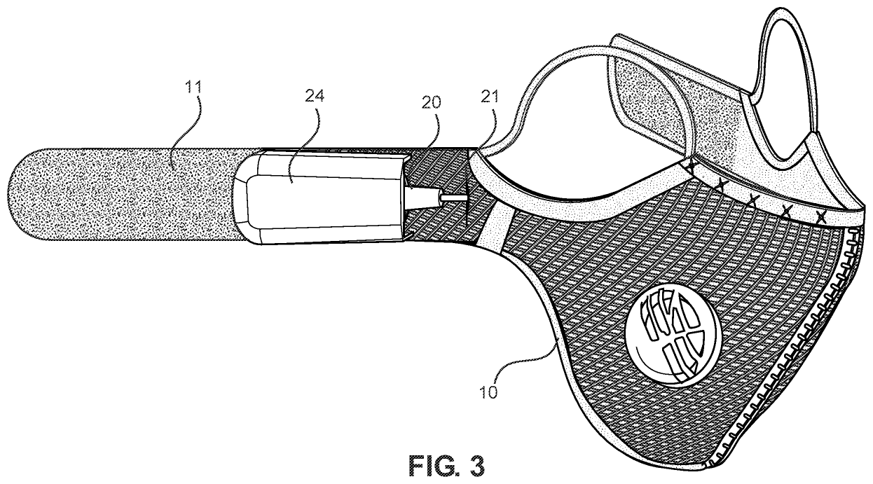

Referring now to FIG. 3, there is shown a side elevation view of an exterior side of an embodiment of the facemask with electronic components. The wired connection 19 extends through an opening 21 in the mask body 10. The electronics housing 20 is removably secured within the pocket 24 for protection, and can be removed to prevent it from being damaged when cleaning the mask body 10. In the shown embodiment, the electronics housing 20 is secured to the head strap 11. However, the electronics housing may be attached to other locations on the mask body 10. In yet another embodiment, the electronics housing 20 comprises a waterproof enclosure and is integrated within the layers of the mask body 10.

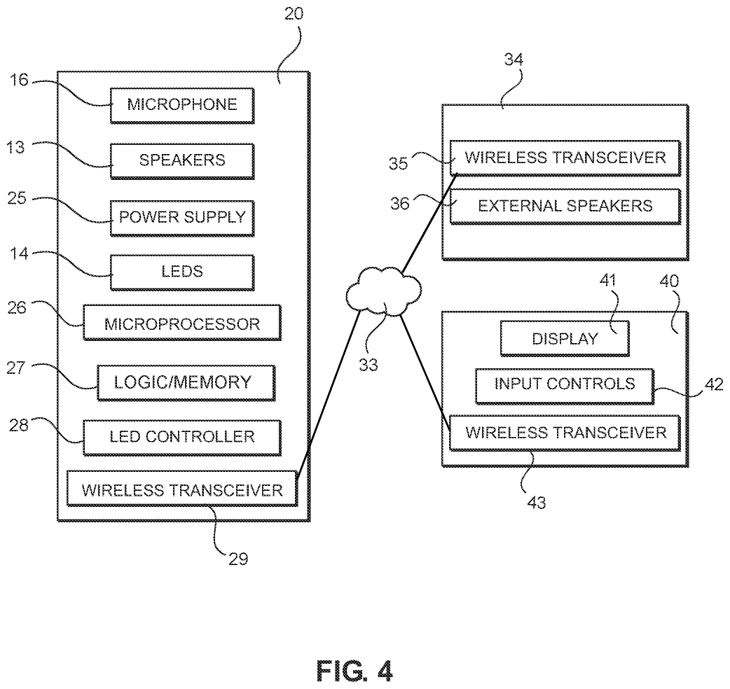

Referring now to FIG. 4, there is shown a block diagram of the electronic elements of an embodiment, of the facemask with electronic components, as well as external devices that interact with the facemask. The electronics 20 include the microphone 16, LEDs 14, and speakers 13. The electronics housing houses a power supply 25 which powers the various electronic components of the system. In one embodiment, the power supply is a rechargeable battery, which can be removed to be charged via an external charging device, or which can include a charging port for connection to an external power source. The power supply 25 powers the microphone 16, speakers 13, a microprocessor 26, a plurality of LEDs 14 operably connected to an LED controller 28, and a wireless transceiver 29. The microprocessor 26 is operably connected to the LED controller 28 and to a non-transitory computer readable medium, such as a memory and stored logic 27. The logic 27, when executed by the microprocessor 26, causes the facemask to perform a method, which is detailed below.

The wireless transceiver 29 is configured to receive and transmit audio information and command instructions wirelessly via a wireless network 33. This may include a bluetooth network, a wireless local area network (WLAN), an internet connection, or any other suitable wireless communications protocol. In one embodiment, the wireless transceiver 29 receives, from a remote device 40, a command instruction comprising one or more LED patterns. The remote device 40 can include a dedicated remote controller, a smartphone, or other similar device with a display 41, input controls 42, and its own wireless transceiver 43. After receiving command instructions, the microprocessor 26 activates the LED controller 28 to cause the plurality of LEDs 14 to illuminate in the one or more LED patterns. This can include programmed timing, colors, and the like. In some embodiments, the memory and logic 27 includes audio analyzer software which instructs the LED controller 28 to illuminate the LEDs 14 in a pattern corresponding to the volume or frequency of an external music file or other audio source.

The wireless transceiver 29 allows other command instructions to be received. For example, the wireless transceiver 29 can receive, via the remote device 40, an instruction regarding which speaker to transmit audio from the microphone 16. If instructed by the remote device 40, the microprocessor 26 causes the speakers 13 to emit audio recorded by the microphone upon receiving a corresponding command instruction via a wireless transceiver of a remote device 40. The microprocessor 26 may also cause the wireless transceiver 29 to transmit the recorded audio to an external audio device 34. This device includes its own wireless transceiver 35 and connected speakers 36. In this way, the wearer's amplified voice can be played in remote locations, or through many speakers spread throughout a single building, as one example. The onboard speakers 13 can act as personal monitoring devices as well as amplifiers for individuals closer to the wearer. Further, in some embodiments, the wireless transceiver 29 may also receive ra command instruction comprising an input sensitivity level for the microphone. This allows the user to lower the sensitivity to prevent the microphone 16 from picking up unwanted breathing noises or the like.

In operation, the user can wear the facemask and use a remote device with dedicated software to program its various electronic functions. The user can select the input sensitivity, noise cancelling software, or other features that enhance the microphone. The remote device can select the desired pattern for the onboard LEDs, including custom patterns or music-related patterns. The user can also select whether the microphone audio is transmitted through one of or both of the onboard speakers and a remote audio device having its own network of speakers. In this way, the facemask provides personal protection, customizable audio amplification, and customizable external LEDs for enhancing overall entertainment value.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, and all equivalent relationships to those illustrated in the drawings and described in the specification are intended to be encompassed by the present invention. Therefore, the foregoing is considered as illustrative only of the principles of the invention. Further, it is not desired to limit the invention to the exact construction and operation shown and described, and accordingly, all suitable modifications and equivalents may be resorted to, falling within the scope of the invention.

I claim:

1) A facemask with electronic components, comprising:
a mask body including one or more straps configured to secure the mask body around to the head of a wearer such that the mouth and nose of the wearer are covered by the mask body;
a power supply operably connected to a microphone, a speaker, a microprocessor, a plurality of LEDs operably connected to an LED controller, and a wireless transceiver;
the microprocessor operably connected to the LED controller and a non-transitory computer readable medium;
a logic stored in the non-transitory computer readable medium that, when executed by the microprocessor, causes the facemask to perform a method, the method comprising:
receiving, from a remote device and via the wireless transceiver, a command instruction comprising one or more LED patterns; and
activating the LED controller to cause the plurality of LEDs to illuminate in the one or more LED patterns.

2) The facemask with electronic components of claim 1, wherein the facemask comprises a material adapted to maintain an N95 filter rating.

3) The facemask with electronic components of claim 1, wherein the facemask comprises an inner layer of material, an outer layer of material, and a filter layer between the inner layer of material and outer layer of material.

4) The facemask with electronic components of claim 3, wherein the filter layer is removably secured between the inner layer of material and outer layer of material via a pocket.

5) The facemask with electronic components of claim 3, wherein the filter layer is adapted to act as a pop filter for the microphone.

6) The facemask with electronic components of claim 1, wherein the microphone is removably secured within an interior portion of the mask body via a fastener.

7) The facemask with electronic components of claim 1, wherein the microphone includes a wired connection to an electronics housing that is disposed on an exterior portion of the mask body, wherein the power supply, the microprocessor, the LED controller, the wireless transceiver, and the non-transitory computer readable medium are stored within an interior of the electronics housing.

8) The facemask with electronic components of claim 7, wherein the electronics housing is removably secured within a pocket on an exterior portion of the mask body.

9) The facemask with electronic components of claim 1, wherein the method further comprises:
receiving, from a remote device and via the wireless transceiver, a command instruction comprising a sensitivity level for the microphone.

10) The facemask with electronic components of claim 1, wherein the method further comprises:
receiving, from a remote device and via the wireless transceiver, a command instruction comprising a remote speaker location; and
wirelessly transmitting audio recorded by the microphone to the remote speaker via the wireless transceiver.

11) The facemask with electronic components of claim 1, wherein the speaker comprises a pair of speakers, with a first speaker disposed on a first side of the mask body and a second speaker disposed on a second side of the mask body.

12) The facemask with electronic components of claim 1, wherein the plurality of LEDs comprise a plurality of LED strands woven into an exterior layer of the mask body.

13) The facemask with electronic components of claim 12, wherein the plurality of LED strands include multiple different color LEDs or LEDs capable of emitting different colors.

14) The facemask with electronic components of claim 1, wherein the one or more straps comprises an adjustable head strap and a pair of ear loops.

15) The facemask with electronic components of claim 1, wherein the speaker is configured to emit, audio recorded by the microphone upon receiving a corresponding command instruction via a wireless transceiver of a remote device.

16) The facemask with electronic components of claim 1, wherein the power supply comprises a rechargeable battery.
